(19) United States
(12) Patent Application Publication
(10) Pub. No.: US 2023/0103721 A1
(43) Pub. Date: Apr. 6, 2023

(54) Method for Selecting a Satellite Combination for a Position Determination

(71) Applicant: Robert Bosch GmbH, Stuttgart (DE)

(72) Inventors: Jens Strobel, Freiberg Am Neckar (DE); Mohammad Tourian, Stuttgart (DE)

(21) Appl. No.: 17/928,522

(22) PCT Filed: Jun. 1, 2021
(86) PCT No.: PCT/EP2021/064626

§ 371 Date: Nov. 29, 2022

(30) Foreign Application Priority Data
Jun. 4, 2020 (DE) 10 2020 206 975.1

(51) Int. Cl. G01S 19/28; G01S 19/42; G01S 19/25

(52) U.S. Cl. CPC G01S 19/28; G01S 19/258; G01S 19/426

(57) ABSTRACT

A method for selecting a combination of GNSS satellites to carry out a position determination from a plurality of visible GNSS satellites in a GNSS receiver taking account of the variance of the satellite signals of the respective GNSS satellites includes: a) sorting the visible GNSS satellites using at least two different sorting algorithms according to predefined criteria catalogues which take account of the variance of the satellite signals, and determining at least two satellite presortings which determine GNSS satellites of which the satellite signals have a low variance according to the relevant predefined criteria catalogue; b) selecting a weighting function for weighting the satellite presortings ; c) creating a final satellite sorting by a weighting of the satellite presortings according to the relevant weighting function, so that a weighted final satellite sorting is produced; and d) carrying out a satellite combination selection on the basis of the final satellite sorting.

### PRIOR ART

With the help of global satellite navigation systems (GNSS), it is possible to determine positions anywhere on Earth. A GNSS satellite is in Earth orbit and transmits encoded signals, which are received by GNSS receivers and can be used to calculate distances between the receiver and the satellite. This is done by using time differences attributable to the signal propagation time from the GNSS satellite to the receiver to determine the path. The distances to the satellites can be used to estimate the position of the GNSS receiver, provided that signals from a sufficient number of satellites are received. An accurate position determination is typically possible if signals can be received from more than 5 satellites. Currently there are about 120 GNSS satellites in Earth orbits. This means that, from anywhere on Earth, at most approximately 65 satellites are visible within the geometric horizon.

GNSS receivers are typically limited in the number of satellites they can track simultaneously. Given the very large number of GNSS satellites available, there are actually ever more visible satellites than there are GNSS receivers capable of tracking satellites. This raises the question as to which combination of the visible satellites is best suited to carry out a good position determination to ensure high availability and to keep the computational effort of the position determination low.

### DISCLOSURE OF THE INVENTION

With this in mind, the intent is to propose a novel approach for selecting a combination of satellites for position determination.

Here described will be a method for selecting a combination of GNSS satellites to carry out a position determination from a plurality of visible GNSS satellites in a GNSS receiver taking into account the variance of the satellite signals of the respective GNSS satellites comprising the following steps:
a) sorting the visible GNSS satellites using at least two different sorting algorithms according to predefined sets of criteria which take into account the variance of the satellite signals and determining at least two satellite presortings with which GNSS satellites are determined, the satellite signals of which have a low variance according to the respective predefined set of criteria;
b) selecting a weighting function for weighting the satellite presortings created in step a);
c) creating a final satellite sorting by weighting the satellite presortings according to the respective weighting function to obtain a weighted final satellite sorting; and
d) carrying out a satellite combination selection on the basis of the final satellite sorting.

Making this decision as to which combination of satellites to use for position determination in real time is a challenge. The most suitable combination of satellites for position determinations should be based both on geometrical considerations and on any errors that may occur in the signal data provided by the satellites. Such occurring errors, in particular time errors, are in the start times of the respective signal data.

One particular challenge is selecting the best combination of satellites with low computational effort, because selecting the best combination of satellites is an optimization problem with a very large number of variables, which can, as a matter of principle, be solved accurately only with a great deal of computational effort. Described here is therefore an approach using a standardized procedure to achieve a good solution to this problem, which does not claim to always be the best possible solution, but which in many cases does provide a very good quality solution. To use the method in automotive applications, it is in particular necessary to keep the computational effort to find a suitable combination of satellites low. The here-described method can combine different approaches to find a suitable combination of satellites. This is accomplished by using different sets of criteria in step a) to create at least two (preferably at least three) different satellite presortings. These satellite presortings can be combined with one another using the described method. A set of criteria can be understood as a rule according to which the variance of the satellite signals can be estimated. The sorting algorithm is a technical implementation of the respective set of criteria to sort satellites according to said set of criteria. The sorting algorithm is preferably implemented in such a way that the satellite signals are transmitted to it with available additional parameters (such as angle, correction data, etc.) and the sorting algorithm then provides, as an output variable, a listing of the satellites in which the satellites are sorted according to the variance that was estimated with the respective set of criteria. The listing is preferably such that the satellites are sorted with ascending relevance. This means that satellites having a variance that is small according to the respective set of criteria are listed first. Such a list according to a set of criteria and produced using a corresponding sorting algorithm is referred to as a satellite presorting.

It is particularly advantageous if at least one sorting according to an angle-based sorting algorithm, in which a weighting is carried out using angular parameters of the respective GNSS satellites, takes place in step a).

Such angle-based sorting algorithms in particular consider the geometry and the angles of the signal propagation vectors between the GNSS satellites and the GNSS receiver.

It is also advantageous if at least one sorting according to a geometry-based sorting algorithm, in which a weighting is carried out using geometric parameters of the orbit of the respective GNSS satellites, takes place in step a).

Such geometry-based sorting algorithms in particular consider the geometry of the orbits of the respective GNSS satellites.

It is furthermore advantageous if at least one sorting according to a measurement error-based sorting algorithm, in which a weighting is carried out using stored and estimated variance data, takes place in step a).

Measurement error-based sorting algorithms are primarily based on stored variance data, which can in particular be provided from an SV data module.

The SV data module is able to receive or determine data from various sources. Data encoded in GNSS signals, for example, can be determined using the SV data module and extracted from the GNSS data with the help of the SV data module. The SV data module can also store variance data from another data source, which, for example, uses a correction data service that regularly provides new correction data; in each case for a specific time period or point in time. The data provided by the SV data module is regularly defined not only as a function of the present time period or point in time, but typically also as a function of the present position and speed. The data in particular includes information to correct propagation time errors (bias and drift).

Angle-based sorting algorithms and geometry-based sorting algorithms are based on the approach of determining a combination of satellites by minimizing the “geometric dilution of precision” (GDOP), for example. Translated into German, “geometric dilution of precision” roughly means “reduction of precision”. The intent is to minimize this reduction of precision. The reduction of precision refers to a measure of the range of variation of the measured values. This is a function of the relative position of the satellites to one another and to the observer (the GNSS receiver). Generally, cases are favorable in which the angle between a first direction between a first satellite and the location of the GNSS receiver and a second direction between a second satellite and the location of the GNSS receiver is such that only a small reduction of precision occurs as a result of signal errors. Very small angles or angles around 180° are unfavorable. The GDOP is usually stated as a parameter which indicates how well-suited a specific combination of visible satellites is for position determination. A value of 1.0 is the best possible. Values less than 1 are overdetermined and cannot be used. Larger values indicate the potential for optimization of the combination of visible satellites being used.

The here-described method uses a combination of the mentioned different sorting algorithms as an approach to account for both the geometry and any errors that may occur in the signal data provided by the satellites. The method can be used for GNSS localization systems and is in particular suitable for automotive applications. Moreover, the here-described method requires only limited computational effort, and thus only limited computer resources.

The here-described approach is based on the fact that the errors that actually occur in the position determination are caused both by the geometry and by stored information about signal errors.

The signal errors that can be eliminated with measurement error-based sorting algorithms primarily occur as a result of delays in signal propagation between the satellite and the respective GNSS receiver caused by the troposphere or the ionosphere. Inaccuracies in satellite localization and inaccuracies as a result of non-linear transmission paths of the signals, in particular caused by reflections (for example on buildings) on the way from the satellite to the GNSS receiver, cause further inaccuracies or signal errors. To avoid position errors when determining an optimal combination of satellites for position determination, it is therefore advantageous to not only take into account the geometry (as in traditional GDOP approaches), but to also consider such signal errors.

The here-described method ultimately takes into account an overall variance of the measurement together with available variances of correction data and together with the geometry. The satellites are sorted on the basis of an observation variance determined as part of the method and then selected accordingly.

With the objective to exclude specific satellites having particularly inaccurate measurements from the position determination, the modeled variance of the pseudorange measurement is used in step a) with the angle-based sorting algorithms or the geometry-based sorting algorithms.

Pseudoranging is a generally known method for localization using GNSS receivers. So-called pseudoranges are used for position determination. Pseudoranges deviate from true (actual) distances by constant but initially unknown amounts. First, the propagation time of the radio signals from the satellites being used to the observer’s receiver is measured. This results in the current distances of the receiver to the satellites, but not with errors. On the one hand, errors are caused by erroneous (i.e., differing) time measurements in the satellite and in the receiver. On the other hand, errors can be associated with other effects. These include the errors caused by the troposphere or the ionosphere or by reflections (for example on buildings) etc. already described above, for example.

Satellites are typically very precisely (i.e., substantially without errors) synchronized to one another in terms of their time measurements. Thus, errors occur in particular as a result of errors in the time measurement at the GNSS receiver. All distance measurements between the GNSS satellites and the GNSS receiver are therefore typically subject to the same propagation time error, which can be referred to as the pseudorange and which can easily be corrected from the satellite measurements themselves if a sufficient number of satellite measurements are available. This procedure is referred to as pseudorange measurement.

The modeled variance of the pseudorange measurement is determined by combining the measured variance and a variance estimated on the basis of correction data:

$$o b s V a r = m e a s V a r + e s t V a r$$

The modeled variance increases if the respective satellite is positioned low above the horizon, in particular if there are reasons to believe that signal reflections are occurring. Up to this point, the here-described approach has in principle created a negative ranking for satellites having a low position angle above the horizon, and also if there is a likelihood that signal reflections are occurring. This ranking is particularly negative if both a low position angle above the horizon and a likelihood of signal reflections are present.

The measured variance measVar is (as the name implies) determined on the basis of a measurement, whereby the measured variance is corrected for facts which take into account the height of the satellites above the horizon and also possible occurring signal reflections.

The estimated variance estVar is determined on the basis of available correction data, which in particular take into account points in time, the respective orbits of the satellites, code phase shifts, ionospheric effects and tropospheric effects.

Key considerations on how to use the geometry to select the respective combination of satellites in geometry-based sorting algorithms are based on so-called cost functions, which define an effort and can be minimized.

A cost function that is an alternative to the GDOP is inserted here. The estimation was made that the cost function takes into account the direction of the view vector, which describes an (imaginary) line of sight or connecting line from the GNSS receiver to the respective satellite, as follows:

$$J j = {\sum }_{I = 1}^{N} c o s \left(2 {θ}_{i j}\right)$$

θ is the angle between the view vectors to the two satellites i and j. The cost function is carried out for each satellite at each point in time, and the combination of satellites for which this cost function is the lowest is selected.

It is also advantageous if a first weighting function is selected in step b) when a complicated environment, in which view vectors from the GNSS receiver to GNSS satellites can in principle be interrupted, is present.

It is furthermore advantageous if the first weighting function takes into account a satellite presorting determined according to a geometry-based sorting algorithm with a reduced weighting factor.

It is also advantageous if a second weighting function is selected in step b) when open sky conditions are present, and view vectors from the GNSS receiver to GNSS satellites should in principle be free.

Open sky conditions or “open sky” is an established technical term in the context of position determination with a GNSS receiver. Open sky means that the GNSS receiver has an at least substantially free field of view and therefore signals can be received directly (i.e., without signal reflections, etc.) from all or at least a large proportion of the satellites that are geometrically above the horizon from the point of view of the GNSS receiver.

It is furthermore advantageous if the second weighting function takes into account a satellite presorting determined according to an angle-based sorting algorithm with a reduced weighting factor.

The here-described method preferably distinguishes between two cases, namely the case of a complicated environment and the case of a free field of view to the satellites (open sky).

In complicated environments, the GNSS satellites are sorted according to a specific schema which can, for example, assign negative points for the cost function depending on the orientation (line of sight) to the respective satellite. Points are assigned in three different areas:
angle-based, on the basis of the elevation angle;
geometry-based, on the basis of the respective orbits of the satellites; and
measurement error-based on the basis of known or expected measurement errors.

The satellites are sorted based on a weighted combination of the rankings in these different schemes.

The elevation angle can be taken into account at 30 percent, for example. The geometry can further be taken into account at 10 percent and possible measurement errors at 60 percent.

If the field of view is free, the respective weightings can be adjusted, for example to take into account the elevation angle at 10 percent and the geometry at 30 percent.

Also described here are a GNSS receiver configured to carry out the described method, a computer program product for carrying out the described method and an electronic storage medium on which such a computer program product is stored.

The figures discussed in the following explain the described method further, whereby the disclosure is not limited to the illustration in the figures; the figures rather merely show a preferred design example. The figures show:

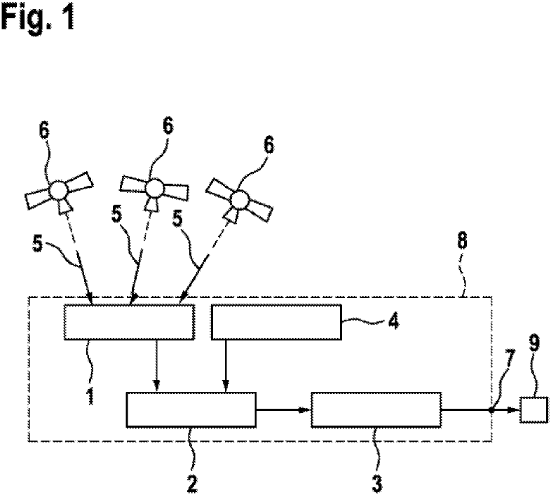

FIG. 1: a GNSS receiver; and

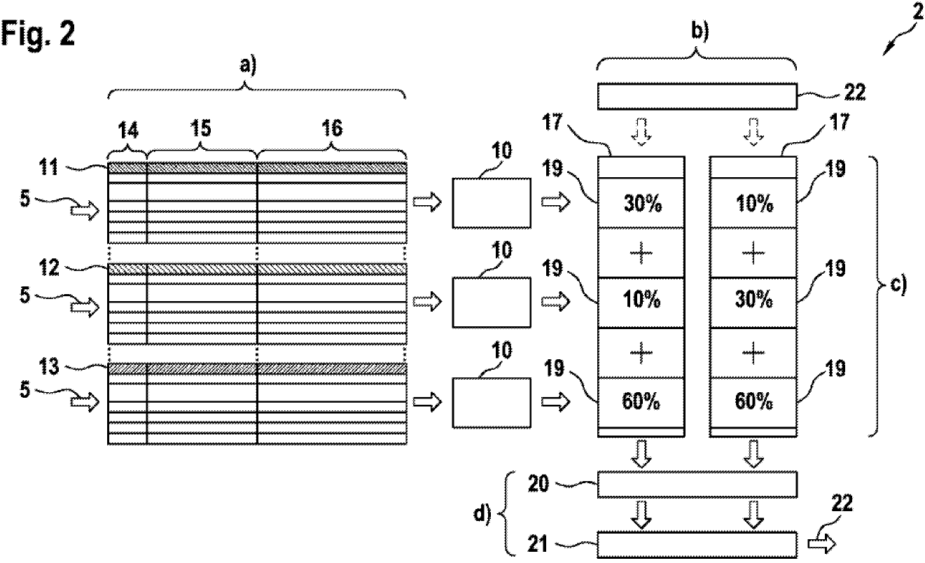

FIG. 2: a diagram of an implementation of the described method;

FIG. 1 shows a GNSS receiver 8, which can carry out position determinations with the help of GNSS satellites 6. Satellite signals 5 from the GNSS satellites 6 are received by a navigation filter module 1. The navigation filter module 1 transmits the GNSS signals to the signal tracker module 2, which is configured to carry out the here-described method and selects or combines GNSS satellites 6 for position determination. To do this, the signal tracker module also accesses data provided by the SV data module 4. This includes correction data to take into account the ionosphere or the troposphere, for example.

The determined combination of GNSS satellites 6 for position determination is passed to the position determination module 3. The position determination module 3 then determines the respective position based on this combination of GNSS satellites 6 and carries out a provision of position data 7 to further control devices 9. Such control devices 9 can be part of further systems in a motor vehicle, for example.

FIG. 2 shows a detailed diagram for carrying out the described method. The modules and algorithms shown in FIG. 2 are preferably implemented in the signal tracker module 2.

First, the satellite signals 5 are determined and processed using various sorting algorithms 11,12, 13. This corresponds to step a). In an angle-based sorting algorithm 11, weighting and sorting is carried out using angle parameters of the respective GNSS satellites 6. In a geometry-based sorting algorithm, weighting and sorting is carried out using parameters of the orbit of the respective GNSS satellite 6. In a measurement error-based sorting algorithm, weighting and sorting is carried out using stored and estimated variance data.

Each sorting algorithm preferably comprises a set of criteria 15, which is sorted according to a ranking order 14 and which is processed in sequence to determine the satellite presorting 10. Cost parameters 16, which indicate the manner in which the respective criterion of the set of criteria affects the satellite presorting 10, are preferably stored for each criterion in the set of criteria 15.

Thus, three different satellite presortings 10 are created, each of which is then weighted according to a weighting function 17, 18 to determine a final satellite sorting 20. This corresponds to step c) of the described method. The position of the individual GNSS satellite in the final satellite sorting 20 can shift compared to the satellite presorting 10. There is preferably a first weighting function 17, which is selected when a complicated environment, in which view vectors from the GNSS receiver to GNSS satellites can in principle be interrupted, is present. There is preferably a second weighting function 18, which is selected when a free field of view is present and view vectors from the GNSS receiver to GNSS satellites should in principle be free. The appropriate weighting function 17, 18 is selected with the help of a selection module 22, which in particular also takes into account the (suspected) current position in order to select the correct weighting function 17, 18. This corresponds to step b) of the described method.

A satellite combination selection 21 is then carried out on the basis of the final satellite sorting 20. This corresponds to step d) of the described method.

1. A method of selecting a combination of global satellite navigation systems (GNSS) satellites to carry out a position determination from a plurality of visible GNSS satellites in a GNSS receiver taking into account variance of the satellite signals of the respective GNSS satellites, comprising:
sorting the visible GNSS satellites using at least two different sorting algorithms according to predefined sets of criteria which take into account the variance of the satellite signals and determining at least two satellite presortings with which GNSS satellites are determined, the satellite signals of which have a low variance according to the respective predefined set of criteria;
selecting for each of the satellite presortings a respective weighting function for weighting the associated satellite presortings;
creating a final satellite sorting by weighting the satellite presortings according to the respective weighting function to obtain a weighted final satellite sorting ; and
carrying out a satellite combination selection on the basis of the final satellite sorting.

2. The method according to claim 1, wherein sorting the visible GNSS satellites comprises:
at least one sorting according to an angle-based sorting algorithm, in which a weighting is carried out using angular parameters of the respective GNSS satellites .

3. The method according to claim 1, wherein sorting the visible GNSS satellites comprises:
at least one sorting according to a geometry-based sorting algorithm, in which a weighting is carried out using geometric parameters of a respective orbit of the respective GNSS satellites.

4. The method according to claim 1, wherein selecting for each of the satellite presortings a respective weighting function comprises:
selecting a first weighting function when a complicated environment, in which view vectors from the GNSS receiver to GNSS satellites can be interrupted, is present.

5. The method according to claim 4, wherein the first weighting function takes into account a satellite presorting determined according to a geometry-based sorting algorithm with a reduced weighting factor.

6. The method according to claim 1, wherein selecting for each of the satellite presortings a respective weighting function comprises:
selecting a second weighting function when open sky conditions are present, and view vectors from the GNSS receiver to GNSS satellites are free.

7. The method according to claim 6, wherein the second weighting function takes into account a satellite presorting determined according to an angle-based sorting algorithm with a reduced weighting factor.

8. A global satellite navigation systems (GNSS) receiver configured to carry out the method according to claim 1.

9. A computer program product configured to carry out the method according to claim 1.

10. An electronic storage medium on which a computer program product according to claim 9 is stored.
